(19) United States
(12) Patent Application Publication
(10) Pub. No.: US 2023/0224631 A1
(43) Pub. Date: Jul. 13, 2023

(54) BEAMFORMING MICROPHONE WITH LOUDSPEAKER

(71) Applicant: Shure Acquisition Holdings, Inc., Niles, IL (US)

(72) Inventors: Gregory William Lantz, Geneva, IL (US); Benjamin Neal Huyck, Chicago, IL (US); Jan Michael Melin, Niles, IL (US); Wade K. Fournier, Spring Grove, IL (US); Sarah N. Kenkel, Schaumburg, IL (US); Scott D. Harlow, Chicago, IL (US); Mathew T. Abraham, Colorado Springs, CO (US)

(21) Appl. No.: 18/152,605

(22) Filed: Jan. 10, 2023

Related U.S. Application Data
(60) Provisional application No. 63/298,169, filed on Jan. 10, 2022.

(51) Int. Cl. H04R 1/28; H04R 1/02

(52) U.S. Cl. CPC H04R 1/288; H04R 1/026; H04R 1/023

(57) ABSTRACT

A communications device is described that may include a system housing, a microphone array, a loudspeaker, and a loudspeaker housing. The loudspeaker housing is configured to minimize acoustic coupling between the loudspeaker and the microphone array, and at least a portion of the loudspeaker housing is positioned outside of the system housing. The loudspeaker housing may include a plurality of loudspeaker housing mounts. The loudspeaker housing may include first and second halves which may have a gasket between them. The gasket between the first half and the second half of the loudspeaker housing may be configured to dampen vibrations.

### CROSS-REFERENCES TO RELATED APPLICATIONS

This application claims the benefit of U.S. Provisional Patent Application No. 63/298,169 filed on Jan. 10, 2022 and is fully incorporated by reference in its entirety herein. This application is related to U.S. Pat. No. 9,565,493 filed Apr. 30, 2015 and issued Feb. 7, 2017, entitled “Array Microphone System and Method of Assembling The Same.” This application is also related to U.S. Provisional Patent Application No. 63/266,555 filed Jan. 7, 2022 and U.S. patent application Ser. No. 18/151,042 filed Jan. 6, 2023, both entitled “Audio Beamforming With Nulling Control System And Methods.” This application is also related to U.S. Provisional Patent Application No. 63/266,553 filed Jan. 7, 2022 and U.S. patent application Ser. No. 18/151,346 filed Jan. 6, 2023, both entitled “System And Method for Automatic Setup of Audio Coverage Area.” This application is also related to U.S. Provisional Patent Application No. 63/260,750 filed Aug. 31, 2021 and U.S. patent application Ser. No. 17/823,295 filed Aug. 30, 2022, both entitled “Mask Non-Linear Processor For Acoustic Echo Cancellation.” This application is also related to U.S. Provisional Patent Application No. 63/142,711 filed Jan. 28, 2021 and U.S. patent application Ser. No. 17/586,213 filed Jan. 27, 2022, both entitled “Hybrid Audio Beamforming System.” The foregoing patents and patent applications are hereby incorporated by reference into this application in their entireties.

### FIELD

This application generally relates to an array microphone incorporating a loudspeaker. In particular, this application relates to an array microphone incorporating a variety of technologies to allow improved performance of both the microphone array and the loudspeaker.

### BACKGROUND

Conferencing environments, such as conference rooms, boardrooms, video conferencing applications, and the like, can involve the use of microphones for capturing sound from various audio sources active in such environments. Such audio sources may include humans speaking, for example. The captured sound may be disseminated to a local audience in the environment through amplified speakers (for sound reinforcement), and/or to others remote from the environment (such as via a telecast and/or a webcast). The types of microphones and their placement in a particular environment may depend on the locations of the audio sources, physical space requirements, aesthetics, room layout, and/or other considerations. For example, in some environments, the microphones may be placed on a table or lectern near the audio sources. In other environments, the microphones may be mounted overhead to capture the sound from the entire room, for example. Accordingly, microphones are available in a variety of sizes, form factors, mounting options, and wiring options to suit the needs of particular environments.

Traditional microphones typically have fixed polar patterns and few manually selectable settings. To capture sound in a conferencing environment, many traditional microphones can be used at once to capture the audio sources within the environment. However, traditional microphones tend to capture unwanted audio as well, such as room noise, echoes, and other undesirable audio elements. The capturing of these unwanted noises is exacerbated by the use of many microphones.

### SUMMARY

Array microphones having multiple microphone elements can provide benefits such as steerable coverage or pick up patterns (having one or more lobes), which allow the microphones to focus on the desired audio sources and reject unwanted sounds such as room noise. The ability to steer audio pick up patterns provides the benefit of being able to be less precise in microphone placement, and in this way, array microphones are more forgiving. Moreover, array microphones provide the ability to pick up multiple audio sources with one array microphone or unit, again due to the ability to steer the pickup patterns.

However, the position of lobes of a pickup pattern of an array microphone may not be optimal in certain environments and situations. For example, an audio source that is initially detected by a lobe may move and change locations. In this situation, the lobe may not pick up the audio source as well at its new location.

In teleconferencing applications, loudspeakers are used to allow participants to hear the audio from the far end and microphones transmit the participants' speech to the far end. However, the microphones might pick up the sound from the loudspeaker and rebroadcast it to the far end, causing the far-end users to hear an echo of their own voices. Technologies such as acoustic echo cancelation (AEC) are known in the art to reduce the perceived echo. However, the performance of these technologies can be improved by using techniques to limit the extent to which the microphones pick up the loudspeaker output before AEC processing.

In some conference room applications, the loudspeaker may be installed as a separate component, but it would be convenient to include at least one loudspeaker within the same housing as the array microphone. However, including a loudspeaker within an array microphone may potentially increase the extent to which the microphone array picks up the output of the loudspeaker. In addition, including a loudspeaker within an array microphone would potentially cause distortion of the microphone signal and/or loudspeaker output caused by the loudspeaker output energizing components of the array microphone and causing them to vibrate. Accordingly, there is an opportunity for an array microphone that addresses these concerns while incorporating a loudspeaker.

A communications device is described that may include a system housing, a microphone array, a loudspeaker, and a loudspeaker housing. The loudspeaker housing is configured to minimize acoustic coupling between the loudspeaker and the microphone array, and at least a portion of the loudspeaker housing is positioned outside of the system housing. The loudspeaker housing may include a plurality of loudspeaker housing mounts. The loudspeaker housing may include first and second halves which may have a gasket positioned between them. The gasket between the first half and the second half of the loudspeaker housing may be configured to dampen vibrations.

The loudspeaker housing mounts may include a first threaded end, a second threaded end, and an elastomeric center connecting the first and second threaded ends. The elastomeric center may be configured to dampen vibrations. The threaded ends may include an anti-rotation shoulder configured to prevent rotation of the loudspeaker housing mount when the anti-rotation shoulder is engaged within a corresponding hole. The anti-rotation shoulder may have a square cross-section and the corresponding hole may have a matching square opening.

The system housing may also include a sound-permeable screen, a fabric backing adjacent to the sound-permeable screen, and a fabric retainer. The fabric retainer may be positioned between the loudspeaker housing and the fabric backing. The fabric retainer may be elastically deformed between the loudspeaker housing and the fabric backing, causing the fabric backing to be held against the sound-permeable screen.

The communications device may include a frame with a plurality of slots configured to secure the sound-permeable screen and the sound-permeable screen may have edges that are secured within the plurality of slots. The edges may include raised dimples that form an interference fit with the slots when the sound-permeable screen is secured within the slots.

The communications device may also include a Power over Ethernet (PoE) power supply and a loudspeaker amplifier. The amplifier may include a power limitation circuit that may be configured to prevent an average PoE power drawn by the communications device from exceeding a PoE power budget. The amplifier may also be configured to provide temporary peak power to the loudspeaker in excess of the PoE power budget without drawing power in excess of the PoE limit from the PoE power supply. The temporary peak power may be provided by a peak supply capacitor.

The microphone array may be a beamforming microphone array. The microphone array may include concentric rings of microphones. The communications device may also include a digital signal processor within the housing, wherein a designated amount of required signal processing is performed in the digital signal processor. The designated amount may be 100%.

### BRIEF DESCRIPTION OF THE DRAWINGS

FIG. 1 is an isometric view of a communications device, illustrating the general shape and components of the communications device, in accordance with the present disclosure.

FIG. 2 is a partially exploded view of the communications device, illustrating some of the internal components.

FIG. 3 is a view of the bottom of the communications device, illustrating additional components.

FIG. 4 is a partially exploded detailed view of the communications device, illustrating the positioning of the fabric screen retainer and the loudspeaker housing.

FIG. 5 is cross-sectional detailed view of the communications device, illustrating the positions of the loudspeaker housing relative to the back panel and the frame.

FIG. 6 is a cut-away view of the communications device with the back panel removed, illustrating the positioning of the inserts.

FIG. 7 is a view of an example of the loudspeaker housing, illustrating some of its features.

FIG. 8 is a view of an example of the loudspeaker housing, illustrating some of its features.

FIG. 9 is an exploded view of an example of the loudspeaker housing, illustrating some of its features.

FIG. 10 is an illustration of an example of a loudspeaker housing mount, illustrating some of its features.

FIG. 11 is a partial cross-section of the communications device, illustrating how the fabric retainer is compressed when assembled.

FIG. 12 is an isometric view of an example of the fabric retainer, illustrating some of its features.

FIG. 13 is a plan view of an example of the fabric retainer, illustrating some of its features.

FIG. 14 is a cross-section view of the frame as assembled in the device, illustrating the position of the screen and screen gasket in the groove.

FIG. 15 is a detailed view of one corner the screen, illustrating one example of the dimples.

FIG. 16 is a circuit diagram illustrating a simplified example of a loudspeaker amplifier circuit with a current-limiting circuit and a peak supply capacitor.

FIG. 17 is an oscillogram illustrating the effect of engaging of the current-limiting portion of the loudspeaker amplifier circuit.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology. Referring now to the Figures, in which like reference numerals represent like parts, various embodiments of the computing devices and methods will be disclosed in detail.

FIG. 1 is an isometric view of a communications device 100. The communications device 100 includes a system housing 124. The system housing 124 includes a back panel 104 and four frame pieces 108. The frame pieces 108 may be extruded aluminum shapes, extruded polymer shapes, molded polymer components, or other similarly stable structural components. A digital signal processor (DSP) 106 and a loudspeaker housing 200 are fixed to the back panel 104 of the system housing 124.

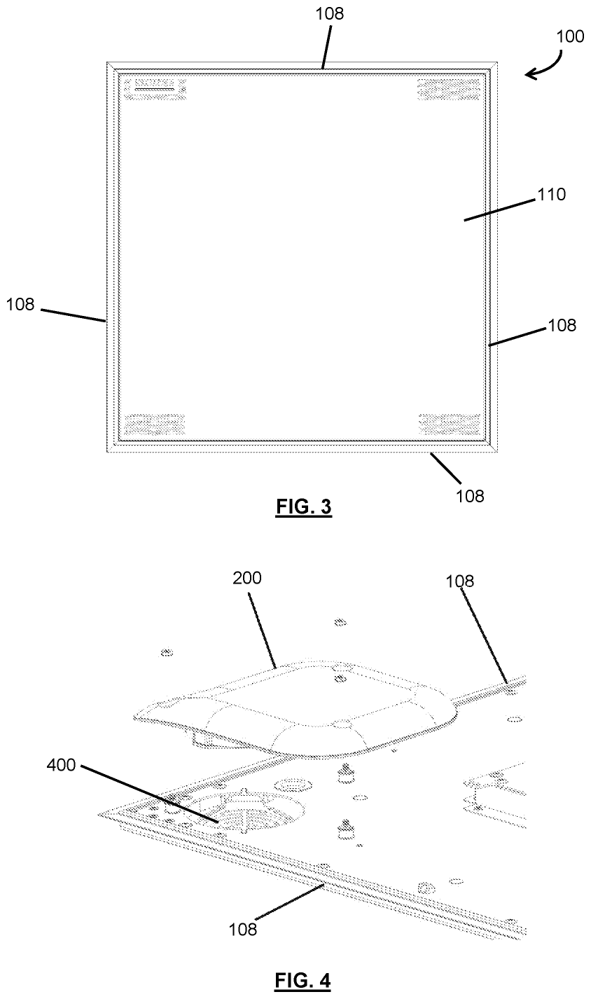

In one example, the system housing 124 may be compatible with mounting in a standard drop ceiling. A drop ceiling is a secondary ceiling, hung below the main (structural) ceiling. It may also be referred to as a drop ceiling grid, T-bar ceiling, false ceiling, suspended ceiling, grid ceiling, drop in ceiling, drop out ceiling, or ceiling tiles, as will be understood by those skilled in the art. In a further example, the system housing 124 may have a square shape. In a further example, the square system housing 124 may be 24 inches×24 inches, 600 mm×600 mm, or 630 mm×630 mm for mounting in a drop ceiling grid. In another example, the system housing 124 may have a flange 134 configured to support the communications device 100 in the drop ceiling grid. In a further example, the flange 134 may be configured to position the communications device 100 such that a portion of communications device 100 extends a fixed amount into the room below the drop ceiling grid. FIG. 3 is a view of the bottom of the communications device 100. The frame pieces 108 are visible as well as a sound-permeable screen 110.

In another example, some portions of the communications device 100 could be circular. For example, the system housing 124 may be circular instead of square. If the system housing 124 is circular, it may include provisions for mounting from a pole (e.g., a VESA pole) or via a suspension cable or cables in a balanced manner. In addition, as discussed below, the microphone array could be circular, including a circular array of microphone elements and/or a circular substrate. Similarly, the loudspeaker 250 could have a circular profile shape. Also, a plurality of loudspeakers could be employed in a circular array.

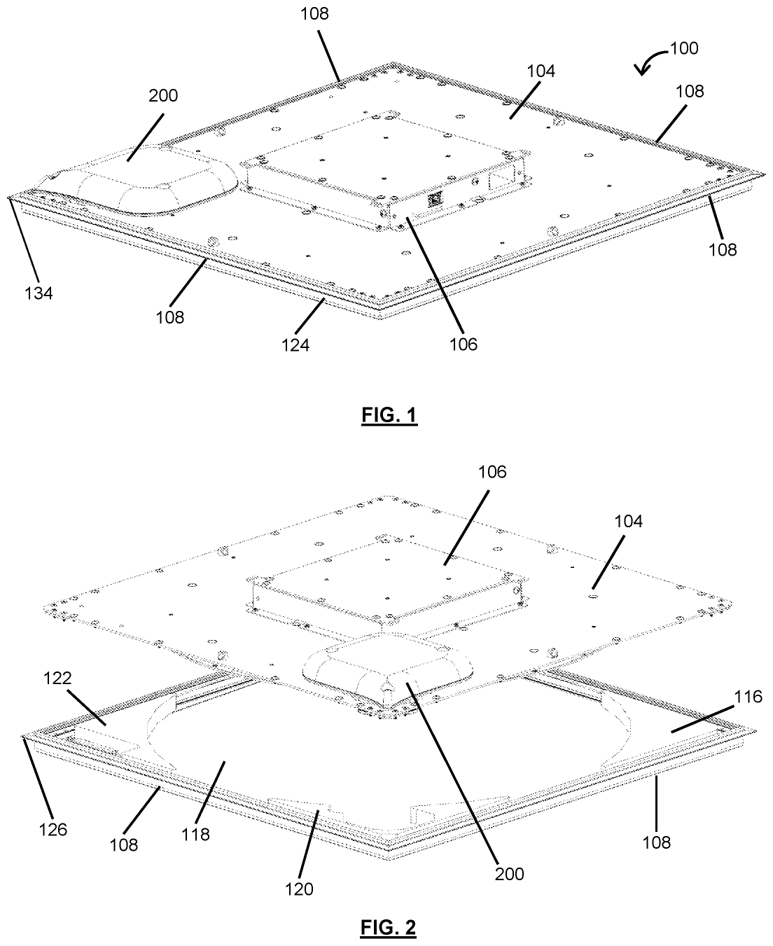

FIG. 2 is a partially exploded view of the communications device 100. The partially exploded view exposes a fabric backing 118 behind the screen 110 as well as four foam inserts 116. The foam inserts 116 are compressed between the screen 110 and back panel 104 when the communications device 100 is assembled. The compression of the inserts 116 helps to hold the fabric backing 118 in place against the screen 110 and reduces vibration of the communications device 100 assembly. In one example, one of the inserts 116 includes a loudspeaker cutout 120 for the loudspeaker 250. In a further example, one of the inserts 116 includes an LED cutout 122 for an LED indicator assembly. FIG. 2 also illustrates a fabric retainer 400, positioned on the back panel 104. The back panel 104 provides a rigid surface to apply force to the fabric retainer 400 and preventing the fabric retainer 400 from moving when the speaker driver is excited. FIG. 4 is a partially exploded detailed view of the communications device 100 illustrating the positioning of the fabric retainer 400 and the back panel 104.

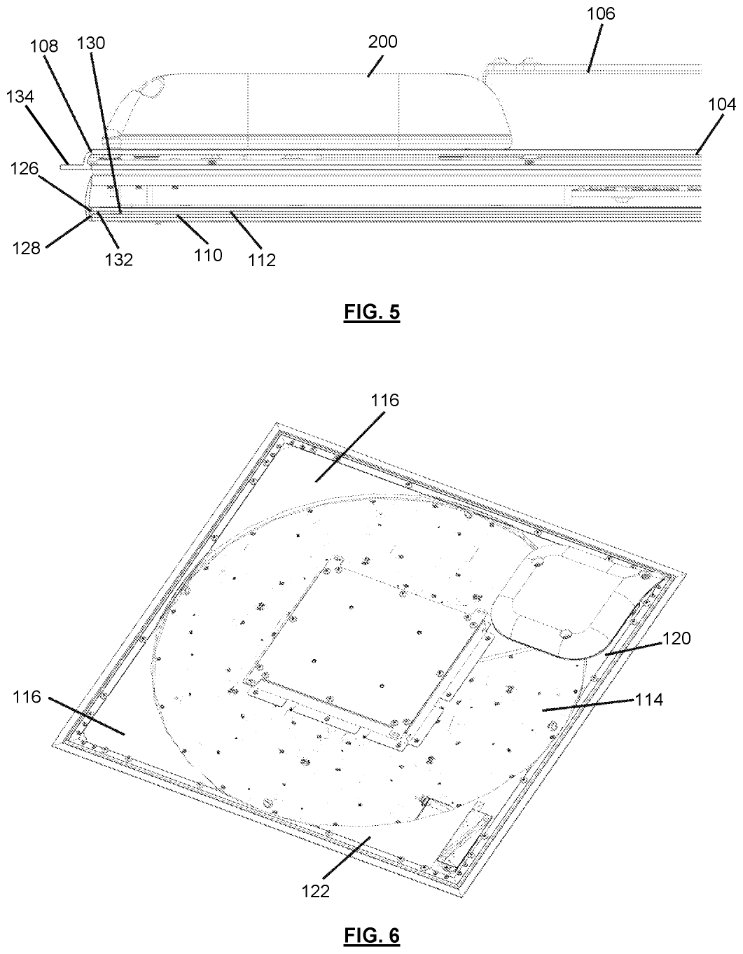

FIG. 5 is cross-sectional detailed view of the communications device 100, illustrating the positions of the loudspeaker housing 200 relative to the back panel 104 and a frame piece 108. In this example, the loudspeaker 250 is fixed to a protrusion 226 on the bottom half 204 of the loudspeaker housing 200, which protrudes through the back panel 104 and into the system housing 124. In an example, positioning a portion of the loudspeaker housing 200 outside of the system housing 124 allows the loudspeaker housing 200 to enclose the needed volume of air without requiring the system housing 124 to be enlarged. FIG. 5 also illustrates how the screen 110 is retained within a slot 126 in the frame piece 108. A screen gasket 112 is also positioned along the edge 128 of the screen 110 in contact with the interior side 130 of the screen 110. The gasket 112 is compressed between the screen 110 and the interior surface 132 of the slot 126. In one example, the gasket 112 may be made from an elastomeric material. In another example, the gasket 112 may be configured to dampen vibrations, including harmonic vibrations. In another example, the gasket 112 may be made from a conductive material, including a conductive elastomer, that is suitable for electromagnetic shielding.

FIG. 6 is a cut-away view of the communications device 100 with the back panel 104 removed. This view illustrates the positioning of the inserts 116. This view also illustrates the microphone array 114. As explained in U.S. Pat. No. 9,565,493, the microphone array 114 comprises a plurality of microphone transducers (also referred to herein as “microphones”) configured to detect and capture sounds in an environment, such as, for example, speech spoken by speakers sitting in chairs around a conference table. The sounds travel from the audio sources (e.g., human speakers) to the microphones. In some embodiments, the microphones may be unidirectional microphones that are primarily sensitive in one direction. In other embodiments, the microphones may have other directionalities or polar patterns, such as cardioid, subcardioid, or omnidirectional, as desired.

The microphones may be any suitable type of transducer that can detect the sound from an audio source and convert the sound to an electrical audio signal. In a preferred embodiment, the microphones are micro-electrical mechanical system (MEMS) microphones. In other embodiments, the microphones may be condenser microphones, balanced armature microphones, electret microphones, dynamic microphones, and/or other types of microphones.

The microphones can be coupled to, or included on, a substrate. In the case of MEMS microphones, the substrate may be one or more printed circuit boards (also referred to herein as “microphone PCB”). For example, the microphones may be surface mounted to the microphone PCB and included in a single plane. In other embodiments, for example, where the microphones are condenser microphones, the substrate may be made of carbon-fiber, or other suitable material.

In embodiments, the microphones can be arranged in concentric, circular rings of varying sizes, so as to avoid undesired pickup patterns (e.g., due to grating lobes) and accommodate a wide range of audio frequencies. As used herein, the term “ring” may include any type of circular configuration (e.g., perfect circle, near-perfect circle, less than perfect circle, etc.), as well as any type of oval configuration or other oblong loop. As explained in U.S. Pat. No. 9,565,493, the rings can be positioned at various radial distances from a central microphone, or a central point of the substrate, to form a nested configuration that can handle progressively lower audio frequencies, with the outermost ring being configured to better operate at the lowest frequencies in a predetermined operating range. Using harmonic nesting techniques, the concentric rings can be used to cover specific frequency bands within a range of operating frequencies.

In embodiments, each ring contains a different subset of the remaining microphones, and each subset of microphones can be positioned at predetermined intervals along a circumference of the corresponding ring. The predetermined interval or spacing between neighboring microphones within a given ring can depend on a size or diameter of the ring, a number of microphones included in the subset assigned to that ring, and/or a desired sensitivity or overall sound pressure for the microphones in the ring. Increasing the number of microphones and a microphone density of the rings (e.g., due to nesting of the rings) can help remove grating lobes and thereby, produce an improved beamwidth with a near constant frequency response across all frequencies within the preset range.

In the illustrated example, the loudspeaker housing 200 is positioned in a corner of the system housing 124, and thus does not interfere with the circular microphone array 114. However, in another example, the loudspeaker housing 200 may be positioned such that the loudspeaker 250 protrudes through the microphone array 114. In such an example, the loudspeaker 250 may be positioned in the space between two microphone elements of the microphone array 114. The microphone array 114 may incorporate a through-hole to accommodate the loudspeaker 250 and/or loudspeaker housing 200.

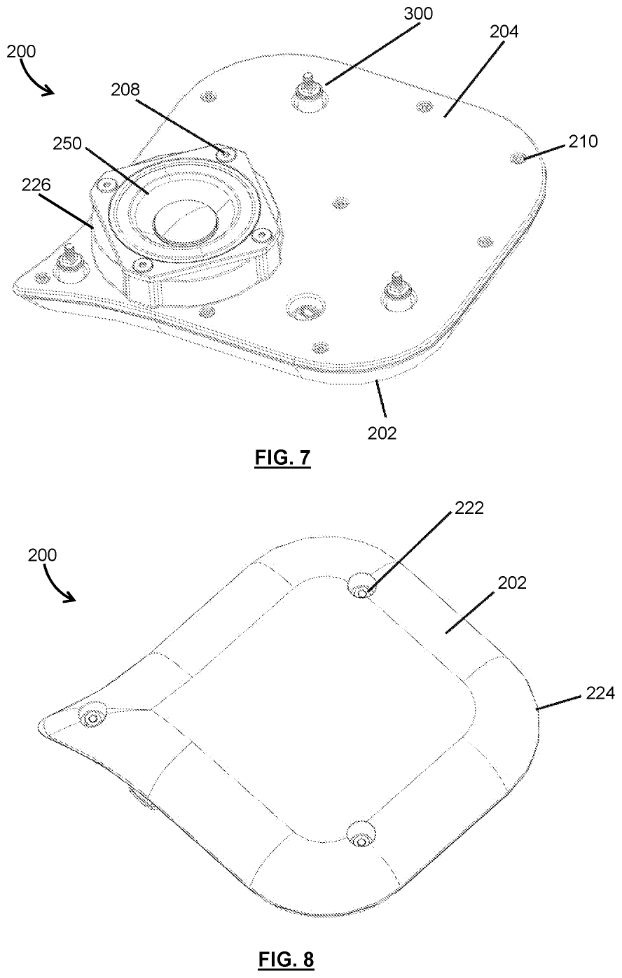

FIGS. 7 and 8 are views of an example of the loudspeaker housing 200, illustrating some of its features. The loudspeaker housing 200 includes a top half 202 and a bottom half 204. The top half 202 is joined to the bottom half 204 with a plurality of screws or other similar fasteners 210. The top half 202 may have rounded corners 224 for positioning within an air-handling plenum. A loudspeaker 250 is fixed to a protrusion 226 on the bottom half 204 of the loudspeaker housing 200 with screws or other fasteners 208. FIGS. 7 and 8 also illustrate an example of the loudspeaker housing mounts 300. The loudspeaker housing mounts 300 may be secured to the loudspeaker housing 200 with nuts or similar fasteners 222.

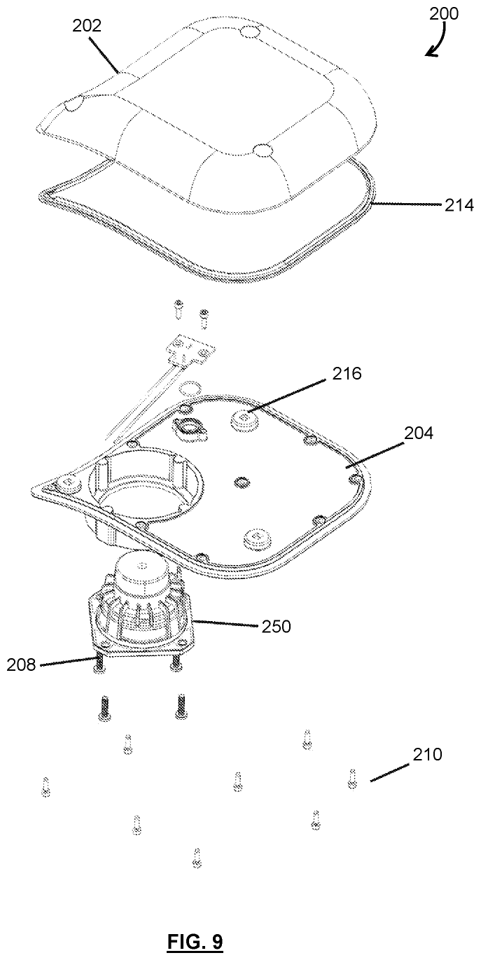

FIG. 9 is an exploded view of the loudspeaker housing 200. In addition to the top half 202 and the bottom half 204, FIG. 9 illustrates an example of a gasket 214 positioned between the top half 202 and bottom half 204 of the loudspeaker housing 200. The gasket 214 may be made of an elastomeric material and may dampen vibrations, including undesirable harmonic vibrations. The gasket 214 may also seal the acoustic volume of the loudspeaker housing 200. To improve audio quality, the loudspeaker 250 may require sealing between the two halves of the loudspeaker housing 200 to contain the air volume inside. Without proper sealing, air leaks may become audible to the user as the speaker energy moves the cone of the loudspeaker 250 up and down, compressing the air volume. The gasket 214 may also be made from a conductive material, including a conducive elastomer, that is suitable for electromagnetic shielding. The interior of the loudspeaker housing 200 may be filled with a foam insert and/or a non-woven media insert (not shown). The foam insert and/or non-woven media insert may be die-cut to accommodate screw bosses and other features of the top half 202 and bottom half 204 of the loudspeaker housing 200. The foam insert and/or non-woven media insert may serve to dampen any standing waves that occur within the interior air volume. Without the foam insert and/or non-woven media insert, users may detect vibrations (and consequently audible noise) at specific frequencies where the standing waves occur.

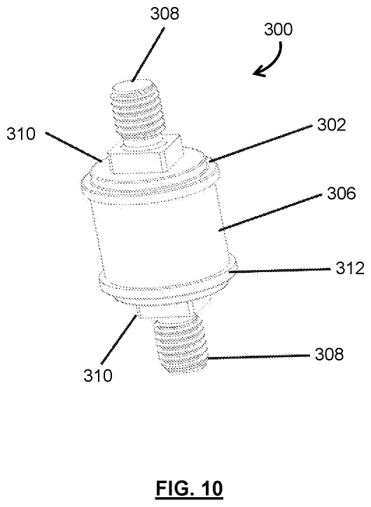

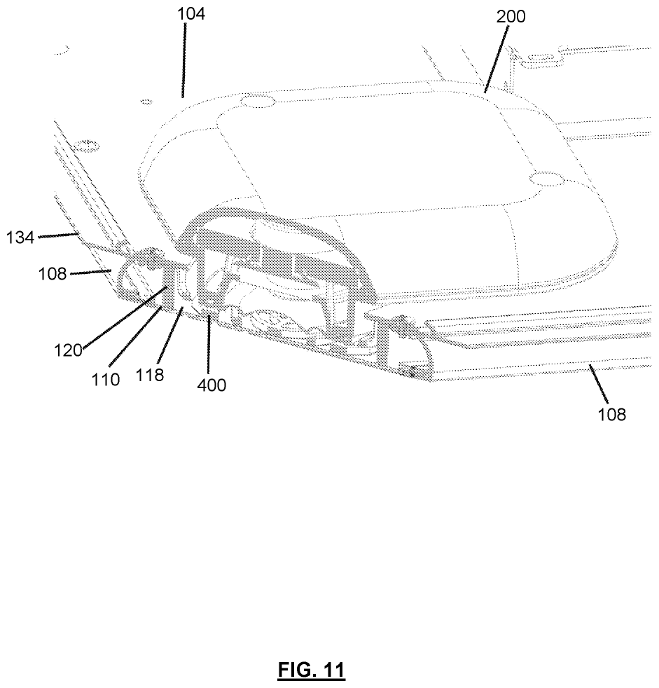

FIG. 10 is an illustration of an example of a loudspeaker housing mount 300. The mount has a first end 302 and second end 312 connected by an elastomeric center 306. The elastomeric center 306 may be made of an elastomeric material and may dampen vibrations, including undesirable harmonic vibrations, and reduce any propensity for the loudspeaker 250 to excite vibrations elsewhere in the communications device 100. The first end 302 and the second end 312 may each have a threaded end 308. The threaded end 308 may be a male thread or female thread. The threaded end 308 also may include an anti-rotation shoulder 310. The anti-rotation shoulder 310 has a shape that engages with mating holes in the back panel 104 of the system housing 124 and the loudspeaker housing 200 (e.g., as shown in FIGS. 1-2). In the example illustrated, the anti-rotation shoulders 310 have square cross-sections that would engage with square holes. However, the anti-rotation shoulders 310 could have many shapes, including triangular, pentagonal, hexagonal, star, or a toothed spline. When the anti-rotation shoulder 310 is engaged with the mating hole, a fastener can be tightened on the threaded end 308 without imparting any torque on the elastomeric center 306 and potentially damaging it. Instead, the reaction torque is provided by the engagement between the anti-rotation shoulder 310 and the mating hole.

FIG. 11 is a partial cross-section of the communications device 100 illustrating how the fabric retainer 400 is compressed when assembled. Compressing the fabric retainer 400 between the fabric backing 118 and back panel 104 causes the fabric backing 118 to be held firmly against the screen 110. This prevents the speaker energy from exciting the fabric backing 118 and causing it to vibrate against the screen 110. In one example, the fabric retainer 400 may be molded in a solid material such as ABS/PC polymer or similar material. In one example, the fabric retainer 400 may be adhered or otherwise fastened to the back panel 104.

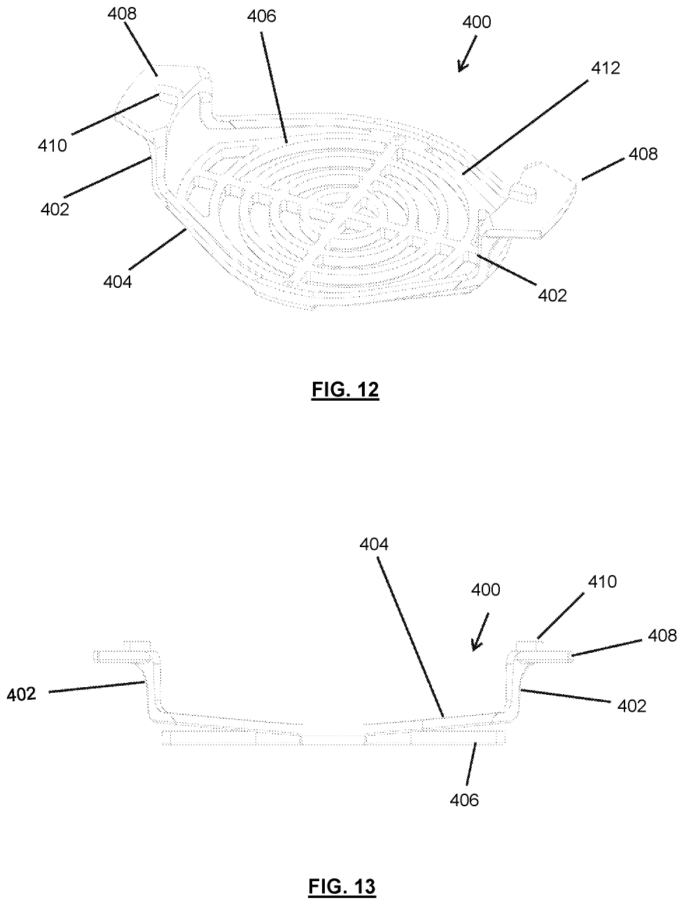

FIGS. 12 and 13 illustrate the features of one example of the fabric retainer 400. In one example, the fabric retainer 400 may have a web 406 of ribs 412 that exert pressure on the fabric backing 118 when the communications device 100 is assembled. In one example, the fabric retainer 400 includes legs 402 that connect the web 406 to mounting tabs 408. The legs 402 include a spring portion 404 that is deflected when the fabric retainer 400 is compressed during assembly of the communications device 100. The deflection of the spring portion 404 provides a consistent spring force to hold the fabric backing 118 against the screen 110. The mounting tabs 408 may also include orientation tabs 410 that assist in properly locating the fabric retainer 400 when it is assembled to the back panel 104. The orientation tabs 410 may facilitate accurate placement of the fabric retainer 400 during assembly. In an example, the fabric retainer 400 may be located near the protrusion 226 holding the loudspeaker 250. If the fabric retainer 400 is positioned inaccurately, the driver of the loudspeaker 250 may contact the fabric retainer 400 and cause noise.

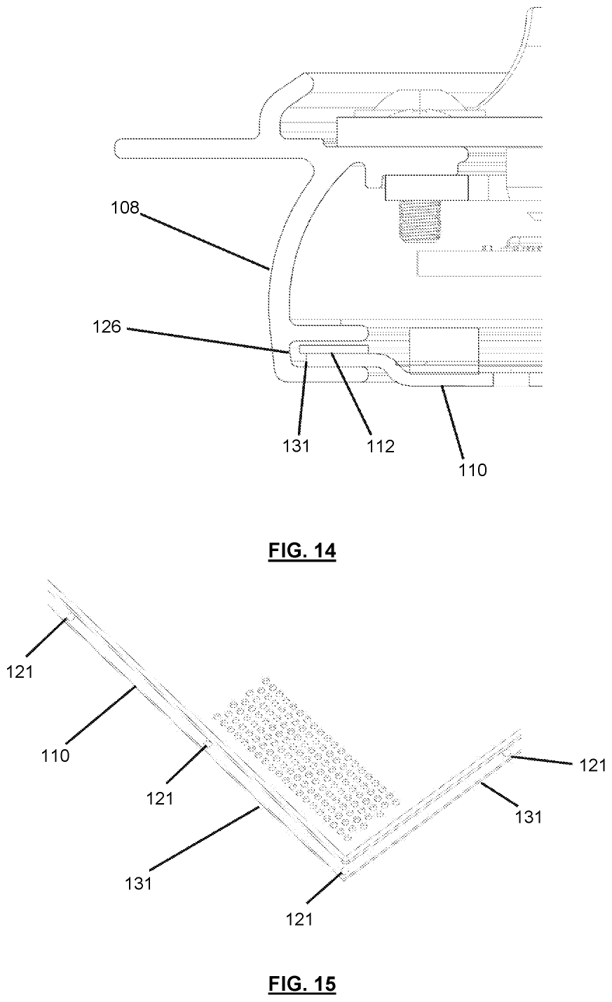

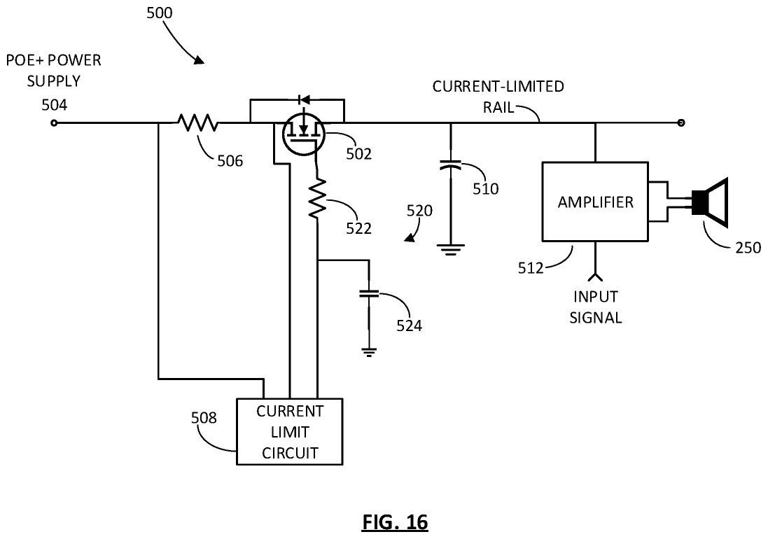

FIG. 14 is a cross-section view of a frame piece 108 showing the position of the screen 110 and screen gasket 112 in the slot 126. FIG. 15 is a detailed view of one corner of the screen 110. In one example, the screen 110 may have numerous dimples 121 formed along its edges 131. In one example, the dimples 121 are raised on one side of the screen 110. The height of the dimples 121 is configured such that when the screen 110 and screen gasket 112 are inserted into the slot 126, the thicknesses of the screen edge 131 plus the screen gasket 112 plus the additional height of the dimple 121 causes an interference fit within the slot 126. The interference fit tends to reduce vibration of the screen 110 caused by audio excitation from the loudspeaker 250. In another example, the dimples 121 may be configured to cause an interference fit without the screen gasket 112. In another example, the dimples 121 may be positioned with a minimum distance between them to provide electromagnetic shielding. The necessary distance between the dimples 121 may be calculated based on the desired shielding frequencies and attenuation, as will be understood by those skilled in the art.

The communications device 100 may be powered by Power over Ethernet plus (PoE+). PoE+ is a protocol that allows a communications device to be powered over the same cables used for Ethernet communication, e.g., “Cat 6” cables. Power over Ethernet (PoE) protocols limit the amount of power that a device can draw, based on the classification of the PoE devices. PoE+ is a class of device under PoE protocols, which allocate a maximum power draw for each PoE+ device. Similar PoE protocols include IEEE 802.3bt (PoE++ or 4PPoE). However, a loudspeaker may, under some circumstances, draw more power or cause the communications device 100 to draw more power than is allowed under these protocols. Accordingly, the communications device 100 may include a loudspeaker amplifier that has a power limitation circuit to prevent the communications device 100 from drawing more power than is allowed by the PoE or PoE+ protocol.

FIG. 16 is a circuit diagram illustrating a simplified example of a loudspeaker amplifier circuit. In one example, a loudspeaker subsystem may be allocated a fixed portion of the total power budget of the communications device 100. In order to prevent the average power consumption of the loudspeaker subsystem from exceeding the subsystem budget, the loudspeaker amplifier circuit may include a current-limitation circuit 500. In one example, the current-limitation circuit 500 incorporates a pass transistor 502 in series between the main PoE supply 504 and the remainder of the loudspeaker amplifier 512, resulting in a current-limited output supplying the loudspeaker amplifier 512. In the example illustrated, the pass transistor 502 is a MOSFET, but other types of transistors may be used, for example, and without limitation, a BJT or an IGBT. Normally, the pass transistor 502 is fully on, powering the amplifier load with very little voltage drop. In one example, the current-limitation circuit 500 may monitor the voltage across a sense resistor 506. An active current limit circuit 508 controls the gate of the pass transistor 502 to limit the voltage across the sense resistor 506 to a predetermined voltage, and thus a predetermined current. The active current limit circuit 508 may be an integrated circuit or may be formed from discrete components. In one example, the current limitation may be pulse-width modulated. In a further example, the current limitation maybe subject to a timing circuit 520. The timing circuit 520 may control the duration that the pass transistor 502 is switched on (conducting) and switched off (not conducting) while the current-limitation circuit 500 is actively limiting the current to the loudspeaker amplifier 512. In the example shown, the timing circuit 520 is an RC circuit including a timing resistor 522 and a timing capacitor 524, but other time-constant circuits may be used, as understood by those skilled in the art.

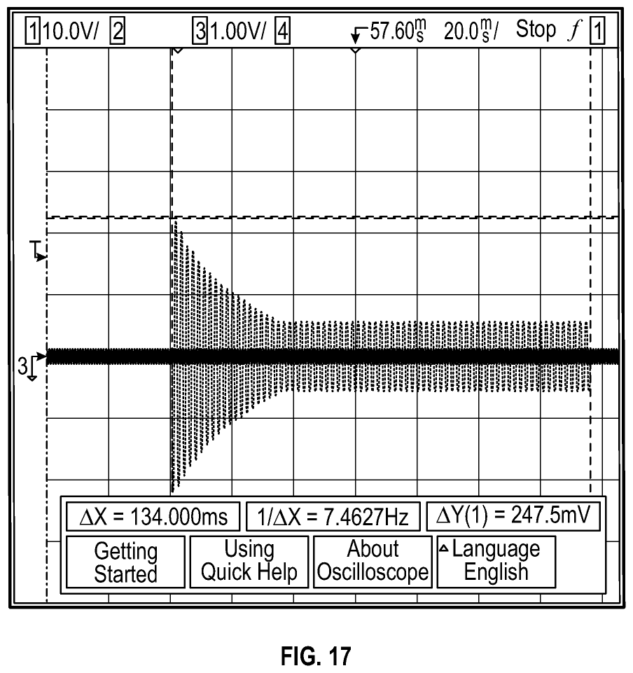

The current-limited power is supplied to the loudspeaker amplifier 512. The loudspeaker amplifier 512 may be an integrated circuit or may be formed from discrete components. In one example, the loudspeaker amplifier 512 may be a Class D amplifier. FIG. 17 is a depiction of an oscillogram illustrating the effect of engaging of the current-limiting portion of the loudspeaker amplifier circuit. When the current-limitation circuit 500 engages to the limit of the power drawn by the loudspeaker amplifier 512, the output of the loudspeaker 250 may be degraded. Specifically, the output of the loudspeaker 250 may be distorted (“squelched”) or suffer from a lack of apparent loudness because the peaks of the loudspeaker signal are being “clipped” because of the limited current to the loudspeaker amplifier 512. In one example, a peak supply capacitor 510 may be added to the current-limitation circuit 500. The peak supply capacitor 510 allows the loudspeaker amplifier 512 to temporarily draw peak power above the subsystem power budget without engaging the active current limitation. The ability of the loudspeaker amplifier 512 to temporarily draw peak power above the subsystem power budget can reduce the incidence of degraded loudspeaker output caused by the current limiting.

In another example, the output of the loudspeaker 250 may be limited by a control circuit in the DSP 106, limiting the amplitude of the input signal to the loudspeaker amplifier 512. In another example, the communications device 100 may limit the power of the loudspeaker 250 using both the analog current-limitation circuit 500 and the control circuit in the DSP 106. In another example, the communications device 100 may be able to differentiate between types of PoE power supplies or sources to which it might be connected. For example, the communications device 100 may be able to identify if it is connected to a “normal” PoE power supply or source, or to a PoE+ power supply or source. If the PoE power supply or source is incapable of providing enough power for both the microphone functions (e.g., the DSP 106) and the loudspeaker functions, the communications device 100 may disable the loudspeaker functions to prevent overloading the PoE power supply or source.

Additional Digital Signal Processing

As explained above, incorporating a loudspeaker within the same system housing as an array microphone can distort the microphone signal and make echo cancelation more challenging. In addition to the physical techniques described above, advanced digital signal processing techniques can be used to improve performance of the microphone array when co-housed with a loudspeaker.

In one example, the lobes of the microphone array can be configured to have an adjustable beamwidth that allows the audio component to effectively track, and capture audio from, human speakers as they move within the environment, as explained in U.S. Pat. No. 9,565,493, which is incorporated herein by reference. In some cases, the microphone array system and/or the control device may include a user control that allows manual beamwidth adjustment. For example, the user control may be a knob, slider, or other manual control that can be adjusted between three settings: normal beamwidth, wide beamwidth, and narrow beamwidth. In other cases, the beamwidth control can be configured using software running on the audio component and/or the control device.

In a further example, the microphone may employ methods that enable more precise control of lobes and nulls of an array microphone are provided. Optimized beamformer coefficients can be generated to result in beamformed signals associated with one or more lobes steered towards one or more desired sound locations and one or more nulls steered towards one or more undesired sound location, e.g., the loudspeaker 250. The performance of the AEC can thus be improved and enhanced. Additional details regarding methods enabling more precise control of lobes and nulls of the array microphone are described in U.S. Provisional Patent Application No. 63/266,555, filed Jan. 7, 2022 and U.S. patent application Ser. No. 18/151,042 filed Jan. 6, 2023, both titled “Audio Beamforming with Nulling Control System and Methods,” which are incorporated by reference herein.

In a further example, multiple microphones or microphone arrays, some of which may include internal loudspeakers, may be used in conjunction with each other. Examples may include an audio system that includes a plurality of microphones disposed in an environment, where the plurality of microphones is configured to detect one or more audio sources, and generate location data indicating a location of each audio source relative to each of the microphones. These audio sources may include loudspeakers, including loudspeakers incorporated within microphone arrays. These microphones may be, but are not limited to, beamforming microphone arrays. In another example, the location data may also be used to communicate the locations of the microphones relative to each other. A processor connected to the microphones may receive the location data from the microphones, and define audio pickup regions in the environment based on the location data. The microphones may then be configured to deploy beamformed lobes in one or more of the audio pickup regions. Additional details regarding methods using multiple array microphones together are described in U.S. Provisional Patent Application No. 63/266,553, filed Jan. 7, 2022 and U.S. patent application Ser. No. 18/151,346 filed Jan. 6, 2023, both titled “System and Method for Automatic Setup of Audio Coverage Area,” which are incorporated by reference herein.

In a further example, AEC performance can be improved by using a non-linear processor (NLP) to assist in suppressing far end single talk leakage, as is known in the art. NLP can be improved by generating a continuous rather than binary mask value that can be used as the gain of a non-linear processor, as described in U.S. Provisional Patent Application No. 63/260,750 filed Aug. 31, 2021 and U.S. patent application Ser. No. 17/823,295 filed Aug. 30, 2022, both titled “Mask Non-Linear Processor For Acoustic Echo Cancellation”, which are incorporated by reference herein. Communication between the loudspeaker 250 and the non-linear processor can be utilized to adjust the threshold of the non-linear processor when the loudspeaker 250 is active to assist in suppressing far end single talk leakage. These techniques can improve the removal of residual echo and therefore enhance the overall performance of the acoustic echo cancellation system when the loudspeaker 250 is located in the same system housing 124 as the microphone array 114.

In a further example, the communications device may utilize a hybrid audio beamforming system that includes a time domain beamformer for processing upper frequency band signals of an audio signal using a time domain beamforming technique, and a frequency domain beamformer for processing groups of lower frequency band signals of the audio signal using frequency domain beamforming techniques. Additional details regarding methods using a hybrid audio beamforming system are described in U.S. Provisional Patent Application No. 63/142,711 filed Jan. 28, 2021 and U.S. patent application Ser. No. 17/586,213 filed Jan. 27, 2022, both titled “Hybrid Audio Beamforming System,” which are incorporated by reference herein.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. For example, one skilled in the art will recognize that executable instructions may be stored on a non-transient, computer-readable storage medium, such that when executed by one or more processors, causes the one or more processors to implement the method described above.

It must also be noted that, as used in the specification and the appended claims, the singular forms “a,” “an” and “the” include plural referents unless the context clearly dictates otherwise. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A communications device comprising:
a system housing;
a microphone array;
a loudspeaker; and
a loudspeaker housing configured to minimize acoustic coupling between the loudspeaker and the microphone array, wherein at least a portion of the loudspeaker housing is positioned outside of the system housing.

2. The communications device of claim 1 wherein the loudspeaker housing further comprises a plurality of loudspeaker housing mounts.

3. The communications device of claim 2 wherein the loudspeaker housing further comprises:
a first half;
a second half; and
a gasket between the first half and the second half

4. The communications device of claim 3 wherein the gasket is configured to dampen vibrations and to be an acoustic seal between the first half and the second half of the loudspeaker housing.

5. The communications device of claim 2 wherein each of the plurality of loudspeaker housing mounts comprises:
a first threaded end;
a second threaded end; and
an elastomeric center connecting the first and second threaded ends.

6. The communications device of claim 5 wherein at least one of the first threaded end and the second threaded end comprises an anti-rotation shoulder configured to prevent rotation of each of the plurality of loudspeaker housing mounts when the anti-rotation shoulder is engaged within a correspondingly configured hole.

7. The communications device of claim 6 wherein the anti-rotation shoulder comprises a square cross-section and the correspondingly configured hole defines a square opening.

8. The communications device of claim 1 wherein the communications device further comprises:
a sound-permeable screen;
a fabric backing adjacent to the sound-permeable screen; and
a fabric retainer.

9. The communications device of claim 8 wherein:
the fabric retainer is positioned between a back panel and the fabric backing; and
the fabric retainer is configured to be elastically deformed between the back panel and the fabric backing, causing the fabric backing to be held against the sound-permeable screen.

10. The communications device of claim 8 further comprising a frame defining a plurality of slots configured to secure the sound-permeable screen;
wherein the sound-permeable screen comprises edges that are secured within the plurality of slots; and
the edges further define raised dimples configured to form an interference fit with the plurality of slots when the sound-permeable screen is secured within the plurality of slots.

11. The communications device of claim 1 further comprising a Power over Ethernet (PoE) power supply.

12. The communications device of claim 11 wherein the communications device is configured to differentiate between the PoE power supply and a PoE+ power supply and to disable the loudspeaker if the communications device is connected to the PoE power supply.

13. The communications device of claim 1 further comprising a loudspeaker amplifier circuit, wherein the loudspeaker amplifier circuit further comprises a current-limitation circuit configured to prevent an average power drawn by the communications device from exceeding a power budget.

14. The communications device of claim 13 wherein the loudspeaker amplifier circuit is configured to provide temporary peak power exceeding the power budget.

15. The communications device of claim 13 wherein the loudspeaker amplifier circuit comprises a peak supply capacitor.

16. The communications device of claim 1 wherein the microphone array comprises a beamforming microphone array.

17. The communications device of claim 15 wherein the microphone array comprises concentric rings of microphones.

18. The communications device of claim 15 further comprising a digital signal processor within the system housing, wherein a designated amount of required signal processing is performed in the digital signal processor.

19. A communications device comprising:
a system housing;
a two-dimensional microphone array; and
a loudspeaker.

20. The communications device of claim 19 wherein the system housing is compatible with a drop ceiling grid.

21. The communications device of claim 20 wherein the system housing comprises a square shape configured for mounting in a square opening in the drop ceiling grid.

22. The communications device of claim 21 wherein the two-dimensional microphone array comprises a circular substrate.

23. The communications device of claim 22 wherein:
the loudspeaker is positioned at least partially within the system housing; and
the two-dimensional microphone array is positioned at least partially within the system housing.

24. The communications device of claim 23 further comprising a digital signal processor within the system housing, wherein a designated amount of required signal processing is performed in the digital signal processor.

25. The communications device of claim 23 wherein the loudspeaker is mounted in a corner of the system housing.

26. The communications device of claim 21 wherein the system housing is further compatible with mounting by at least one of a VESA pole and suspension cables.

27. The communications device of claim 19, wherein the two-dimensional microphone array comprises a plurality of microphone elements arranged in at least one circular ring.

28. The communications device of claim 27 wherein the plurality of microphone elements are arranged, on a substrate, in a number of concentric, nested rings of varying sizes, each ring comprising a subset of the plurality of microphone elements positioned at predetermined intervals along a circumference of the ring.

29. The communications device of claim 19, wherein the loudspeaker is positioned between at least two microphone elements of the two-dimensional microphone array.

30. A communications device comprising:
a system housing;
a two-dimensional microphone array;
a loudspeaker; and
a loudspeaker amplifier circuit configured to prevent an average power drawn by the communications device from exceeding a power budget.
